(19) United States
(12) Patent Application Publication
(10) Pub. No.: US 2023/0012359 A1
(43) Pub. Date: Jan. 12, 2023

(54) LADDER SECUREMENT DEVICE

(71) Applicant: Jerod Allen, Parkville, MO (US)

(72) Inventor: Jerod Allen, Parkville, MO (US)

(21) Appl. No.: 17/369,432

(22) Filed: Jul. 7, 2021

(51) Int. Cl. E06C 7/48

(52) U.S. Cl. CPC E06C 7/486

(57) ABSTRACT

A ladder securement device for securing a ladder to a building structure includes an elastic cord with first and second attachment hooks for attaching to gutter screws or other structural attachment points. First and second straps are slidably attached to the elastic cord to allow positioning of the straps adjacent to a rail or rung of a ladder. The straps include connection tabs and sockets to allow the straps to be attached around the rail or rung, and an adjustment slot or buckle to allow the straps to be tightened snugly to the rail or rung. With the attachment hooks attached to the structure and the straps attached to the rail or rung of a ladder, the ladder is secured to the structure to prevent the ladder from slipping or tipping.

### BACKGROUND

Ladders are used extensively throughout the United States and the world to provide access to raised areas of buildings. Extension ladders, or sections of extension ladders, are commonly used by homeowners, roofers, painters, inspectors, and others to access to the roof and other elevated areas of business and residential buildings.

Because of their wide usage, and in view of a ladder's narrow width in comparison to the height, ladder tipping accidents are common. Combined with environmental conditions—varying ground surfaces, varying building wall surfaces, etc.—it can be difficult to properly secure a ladder to ensure the safety of a user of the ladder.

Ladder stabilization devices are known in the art. For example, standoff devices with arms that extend outwardly from each side of the upper end of a ladder are known, those devices attach to the upper end of a ladder to provide a wider, more stable stance against a wall or other part of the structure. While useful, such devices are not foolproof and not without problems. For example, if a ladder starts to tip, a standoff device may simply slide along the wall supporting it, without preventing the ladder from tipping.

Because ladder accidents are one of the leading causes of injury and death in household and industrial settings, it can be seen that there remains a need in the art for an improved device that allows a ladder to be secured to better prevent movement, slippage, and tipping of the ladder with which it is used.

### SUMMARY

Embodiments of the invention are defined by the claims below, not this summary. A high-level overview of various aspects of the invention is provided here to introduce a selection of concepts that are further described in the detailed description section below. This summary is not intended to identify key features or essential features of the claimed subject matter, nor is it intended to be used in isolation to determine the scope of the claimed subject matter. In brief, this disclosure describes a ladder securement device for securing a ladder to gutter screws or other fixed points of a structure to prevent the upper end of the ladder from moving or tipping.

In one aspect, the ladder securement device comprises an elastic cord having a hook at each end for attachment to a gutter screw or other fixed structural member of a building. One or more straps are movably attached to the elastic cord, the straps configured to attach around a ladder rail or rung. With the elastic cord extended between two gutter screws and attached to the screws by the hooks, and with the one or more straps positioned along the elastic cord and tightened around the ladder rails and/or rungs, the ladder is secured against the gutter to prevent movement or tipping.

In one embodiment, the ladder securement device includes two straps configured to attach to and secure the side rails of the ladder. In an alternative embodiment, the straps are configured to attach to a rung of the ladder. In a further alternative embodiment, a single strap is configured to attach to a rung or a side rail of a ladder.

### BRIEF DESCRIPTION OF THE DRAWINGS

Illustrative embodiments of the invention are described in detail below with reference to the attached drawing figures, and wherein:

FIG. 1 is a perspective environmental view of a ladder securement device in accordance with a first exemplary embodiment of the present invention in use with a ladder.

FIG. 2 is a close-up partial view of the ladder securement device of FIG. 1 attached to a side rail of a ladder.

FIG. 3 is a close-up view of a portion of the ladder securement device of FIG. 1.

FIG. 4 is a perspective view of the ladder securement device of FIG. 1.

FIG. 5 is a perspective environmental view of a ladder securement device in accordance with a second exemplary embodiment of the present invention in use with a ladder.

FIG. 6 is a close-up partial view of the ladder securement device of FIG. 5 attached to the rung of a ladder.

FIG. 7 is a perspective view of the ladder securement device of FIG. 6.

FIG. 8 is a close-up partial perspective environmental view of a ladder securement device in accordance with a third exemplary embodiment of the present invention in use with a ladder.

FIG. 9 is a perspective view of the ladder securement device of FIG. 8.

FIG. 10 is an alternative embodiment of the ladder securement device of FIG. 4 having attachment hooks with a locking mechanism and hook guard.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about” or “approximately” as used herein denote deviations from the exact value in the form of changes or deviations that are insignificant to the function.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology may be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Such terminology includes the words specifically mentioned, derivatives thereof and words of a similar import.

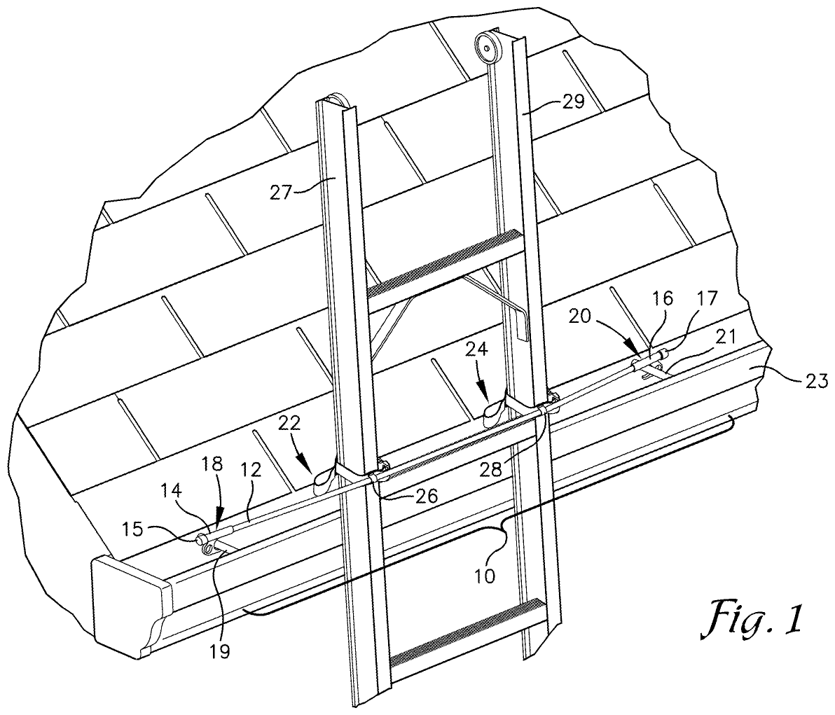

Looking first to FIG. 1, a ladder securement device in accordance with a first exemplary embodiment of the present invention shown in use with an extension ladder is depicted generally by the numeral 10. The ladder securement device 10 comprises an elastic cord 12 which extends between first and second ends 14, 16. First and second attachment hooks 18, 20 are slidably attached around the first and second ends 14, 16, respectively, of the elastic cord 12. The first and second attachment hooks 18, 20 are attached to corresponding first and second gutter screws 19, 21 of the gutter 23 of the structure that the extension ladder is being used with. First and second straps 22, 24 are movably attached around the elastic cord 12 via loops 30, 32, respectively, with the first strap 22 positioned near the left side rail 27 of the extension ladder and the second strap 24 positioned near the right side rail 29 of the extension ladder. The straps 22, 24 extend around, and secure to, the respective side rails 27, 29. First and second caps 15, 17 are attached to the first and second ends 14, 16, respectively, of the elastic cord 12 to contain the attachment hooks 18, 20 and straps 22, 24 on the cord.

With the elastic cord 12 extended between the first and second gutter screws 19, 21, the first and second attachment hooks 18, 20 attached to the gutter screws 19, 21, and with the first and second straps 22, 24 secured to the left and right side rails 27, 29, it can be seen that the extension ladder is secured against the gutter 23 of the structure to prevent the upper end of the ladder from moving or tipping.

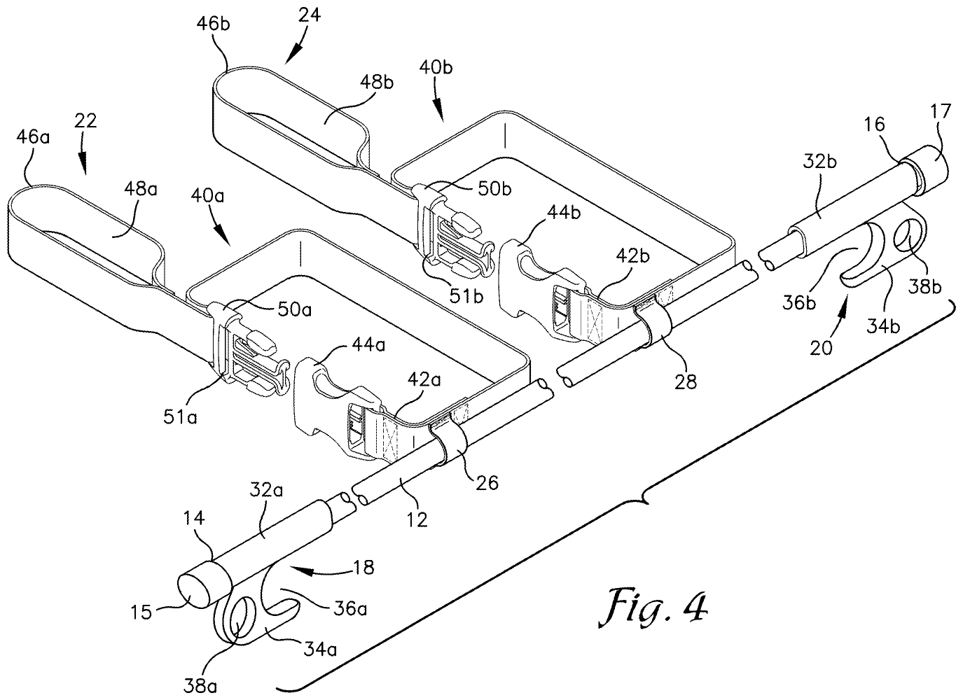

Turning to FIG. 4, a close-up view of the ladder securement device 10 shows the just-described features of the device in more detail. Elastic cord 12 preferably comprises a flexible, stretchable elastic material having a circular cross section, such as a bungee cord, so that the cord 12 is generally cylindrical in shape, extending between first and second ends 14, 16. Caps 15, 17 preferably comprise a hollow cylindrical interior portion configured to fit over the respective ends 14, 16 of the elastic cord 12, and are secured to the ends 14, 16 by gluing or crimping. The outer diameter of the caps 15, 17 is preferably approximately twice the outer diameter of the elastic cord 12 so that the slidably attached first and second attachment hooks 18, 20 and the slidably attached first and second straps 22, 24, are contained on the elastic cord 12 and cannot slide off or be removed from the cord.

First and second attachment hooks 18, 20 each comprise a hollow cylindrical main body portion, 32a, 32b that is fitted around the elastic cord 12 so that each attachment hook can be slidably moved along the elastic cord 12. A protruding tab portion 34a, 34b extends from each main body portion, with a hook 36a, 36b formed in each tab portion, the hook configured to attach to a gutter screw as previously described, or to any other structural member available. An eyelet 38a, 38b formed in each tab portion allows attachment of other hooks, for example to attach a second bungee cord to extend the reach of the elastic cord 12, or to hang up the device when not in use. First and second attachment hooks 18, 20 are preferably formed from a strong, rigid material, such as a plastic, composite, or metal. Most preferably they are formed by molding. It should be apparent that first and second attachment hooks are placed onto the elastic cord 12 prior to the attachment of the end caps 15, 17 so that once the end caps are attached the first and second attachment hooks are trapped onto the elastic cord 12, but able to be slidably moved along the cord as previously described.

Looking still to FIG. 4, straps 22, 24 each comprise an elongated flat main body portion 40a, 40b extending between a first end 42a, 42b where it is attached to a connection socket 44a, 44b, and a second end 46a, 46b which is formed as a looped handle 48a, 48b. A movable connection tab 50a, 50b is slidably attached to the main body portion and is configured to engage with the corresponding connection socket 44a, 44b to secure the strap 22, 24 around a ladder rail or rung. Preferably, straps 22, 24 are formed of a strong, inelastic woven material.

As can be seen in FIG. 4, the main body portion 40a, 40b of the strap passes through a slot in the connection tab 50a, 50b so that the strap 22, 24 can be tightened around a rail or rung of a ladder by pulling on the looped handle 48a, 48b. Thus, with the strap placed around a rail or rung, a user clips the connection tab into the connection socket and pulls the looped handle causing the main body portion to slide through the slot in the connection tab to snug the strap around the rail or rung. When finished using, a user can unclip the connection tab from the connection socket to remove the strap and to slide the main body portion to slacken the strap.

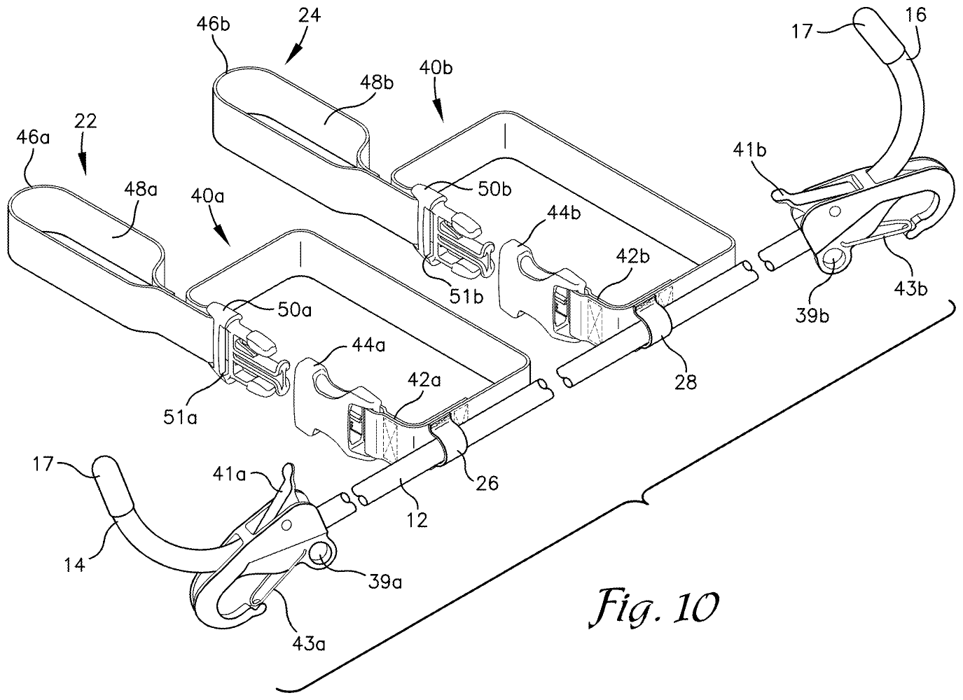

Turning to FIG. 10, in an alternative embodiment of the ladder securement device of FIG. 4 as just described, end caps 15, 17 have a rounded, smooth surface. In this embodiment each of the attachment hooks includes a locking mechanism comprising a lever 41a, 41b with a cam configured to engage the elastic cord so as to lock the hook in a desired position along the elastic cord. Thus, the attachment hooks may be secured as necessary to effectively shorten or lengthen the usable portion of the elastic cord to adjust to varying attachment points on the structure. The attachment hooks further include a wire frame hook guard 43a, 43b that prevent the hook from accidentally slipping from an attachment point, a user must physically move the hook guard in order to remove the attachment hook. Finally, in this alternative embodiment, the eyelets 39a, 39b on each hook are positioned on the inner side of the hook rather than the outer side.

The elastic cord 12 passed through loops 30, 32 attached near the second end 42a, 42b of each corresponding strap 22, 24 to allow the straps to be slidably moved along the cord in a manner similar to that of the attachment hooks 18, 20 as previously described. Thus, the straps 22, 24, can be moved along the length of the elastic cord 12 to allow them to be positioned adjacent to a ladder rail as required.

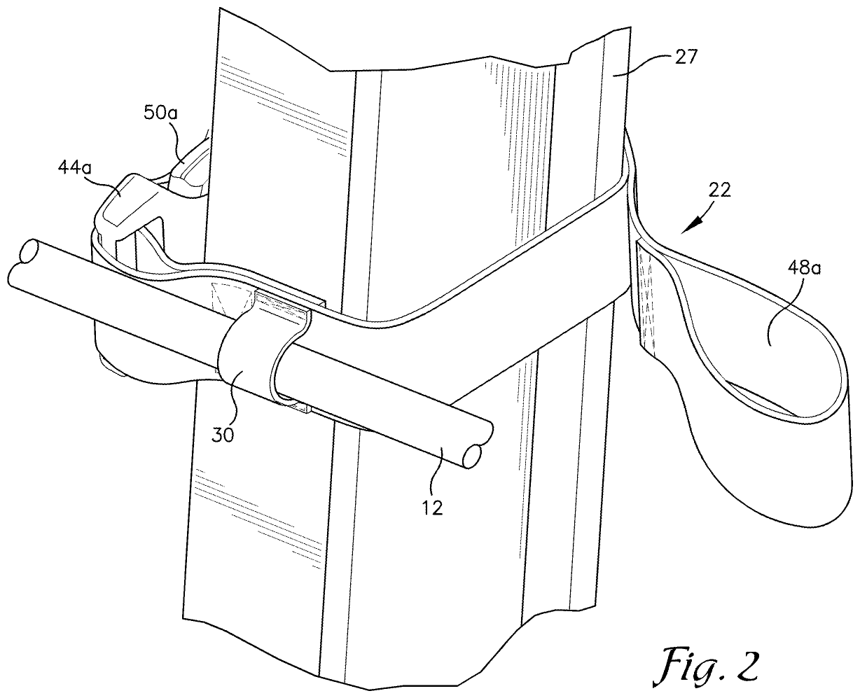

Looking to FIG. 2, a close up view shows the loop 30 attached to strap 22 with the elastic cord 12 passing through, allowing the strap 22 to be slidably moved along the cord. As also seen in that figure, with the connection tab 50a inserted into the connection socket 44a, the strap 22 may be tightened snugly around the ladder rail 27 by pulling the looped handle 48a as previously described.

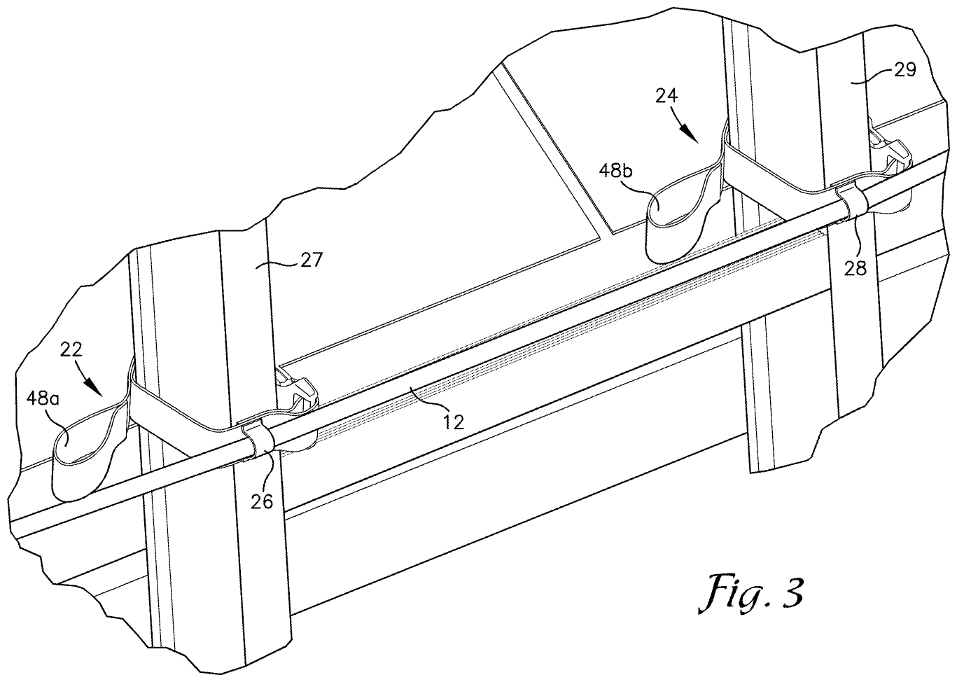

Similarly, FIG. 3 shows first and second straps 22, 24 slidably attached to the elastic cord 12, with the straps 22, 24 tightened snugly around the corresponding ladder rails 27, 29 by pulling the corresponding looped handle 48a, 48b.

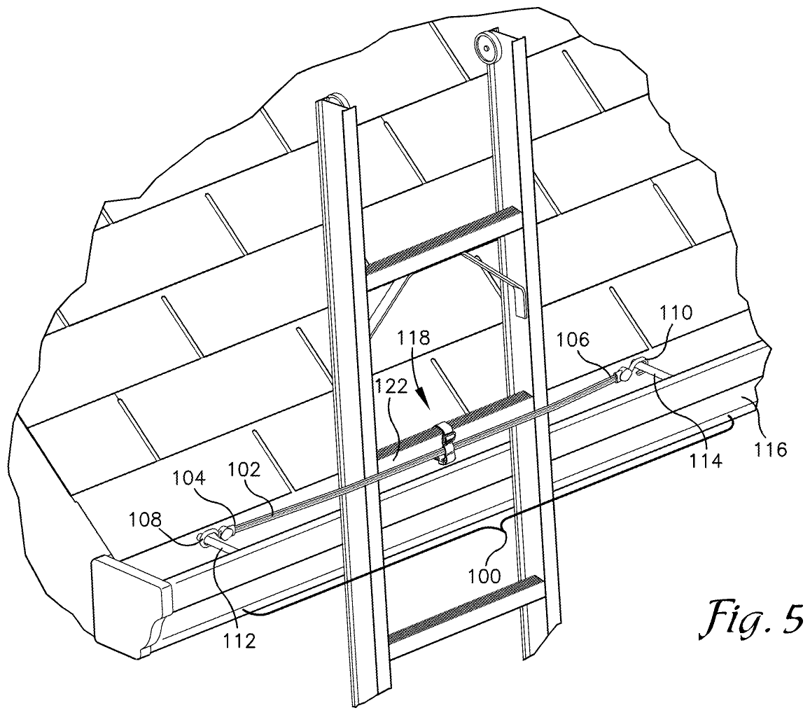

Turning to FIG. 5, a ladder securement device in accordance with a second exemplary embodiment of the present invention is depicted generally by the numeral 100. Ladder securement device 100 comprises an elastic cord 102 extending between first and second ends 104, 106. First and second attachment hooks 108, 110 are attached to the first and second ends, 104, 106, respectively, of the elastic cord 102.

The first and second attachment hooks 108, 110 are attached to corresponding first and second gutter screws 112, 114 of the gutter 116 of the structure that the extension ladder is being used with. A strap 118 is movably attached around the elastic cord 102 via a pocket 120 formed in the strap 118. The strap 118 extends around, and secures to, a rung 122 of the ladder.

With the elastic cord 102 extended between the first and second gutter screws 112, 114, and with the strap 118 secured to the ladder rung 122, the extension ladder is secured against the gutter 116 of the structure to prevent the upper end of the ladder from moving or tipping.

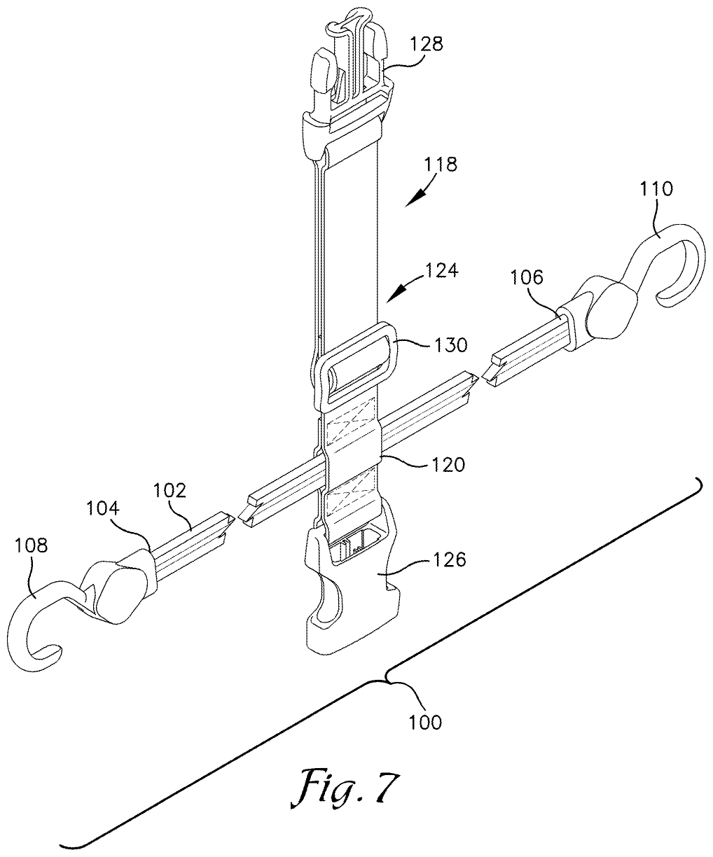

Turning to FIG. 7, a close-up view of the ladder securement device 100 shows the just-described features of the device in more detail. Elastic cord 102 comprises a flat, stretchable elastic material. First and second attachment hooks 108, 110 are crimped, glued, or otherwise attached to the first and second ends 104, 106, respectively, of the elastic cord 102.

Strap 118 comprises an elongated flat main body portion 124 with a pocket 120 formed therethrough to allow the elastic cord 102 to pass through. A connection socket 126 is attached to one end of the strap 118, with a mateable connection tab 128 attached to the opposite end of the strap. The connection tab 128 is configured to mate with and snap into the connection socket 126 to secure the two together with the strap positioned around a ladder rung. The main body portion 124 of the strap 118 passes through an adjustment buckle 130 that allows the strap to be tightened around a ladder rung. Preferably, strap 118 is formed of a strong, inelastic woven material.

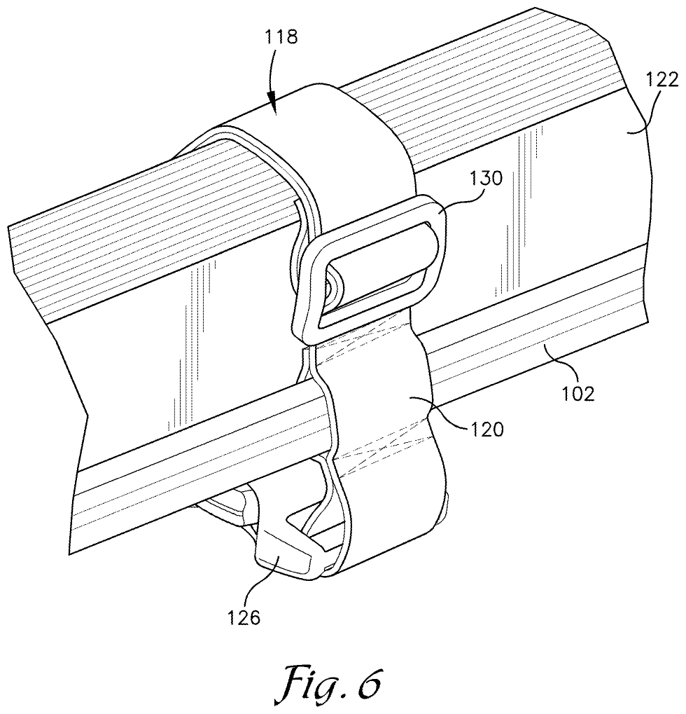

Thus, as seen in FIG. 6, the strap 118 can be tightened around a ladder rung 122 with the elastic cord 102 passing through the pocket 120 to secure the device 100 to the ladder.

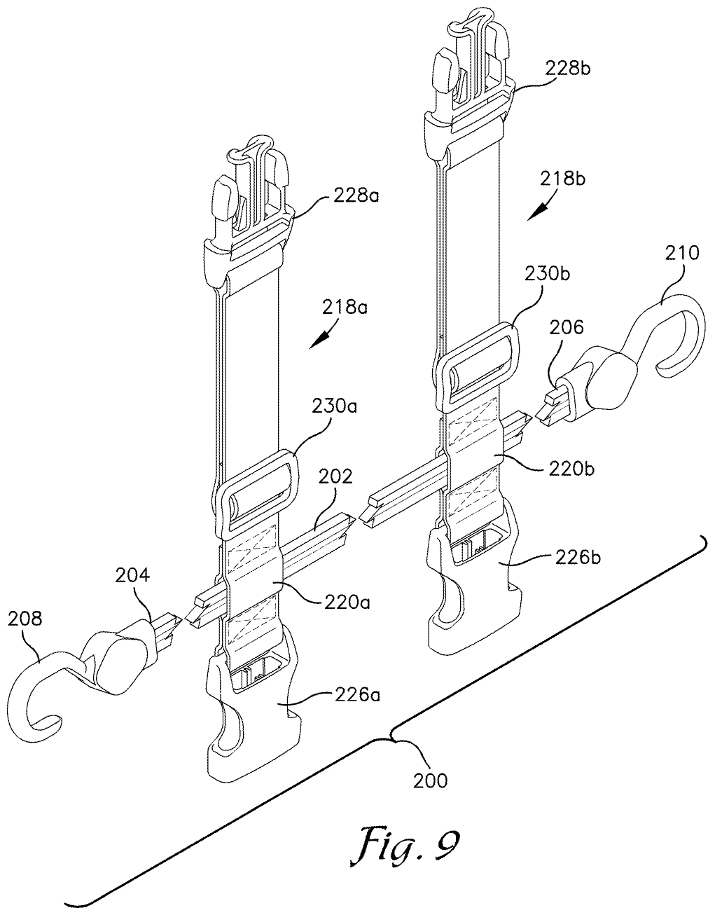

Turning to FIG. 9, a ladder securement device in accordance with a third exemplary embodiment of the present invention is depicted generally by the numeral 200. Ladder securement device 200 is similar to that of the second embodiment as just described with respect to FIG. 7 but includes two straps to attach the device 200 to a ladder rung. Ladder securement device 200 comprises an elastic cord 202 extending between first and second ends 204, 206. First and second attachment hooks 208, 210 are attached to the first and second ends, 204, 206, respectively, of the elastic cord 202.

The first and second attachment hooks 208, 210 are configure to first and second gutter screws of a structure that the extension ladder is being used with. Straps 218a, 218b are movably attached around the elastic cord 202 via a pocket 220a, 220b formed in the corresponding strap 218a, 218b. The straps 218a, 218b each extend around, and secure to, a rung 222 of the ladder.

With the elastic cord 202 extended between first and second gutter screws, and with the straps 218a, 218b secured to the ladder rung 222, the extension ladder is secured against a gutter of the structure to prevent the upper end of the ladder from moving or tipping.

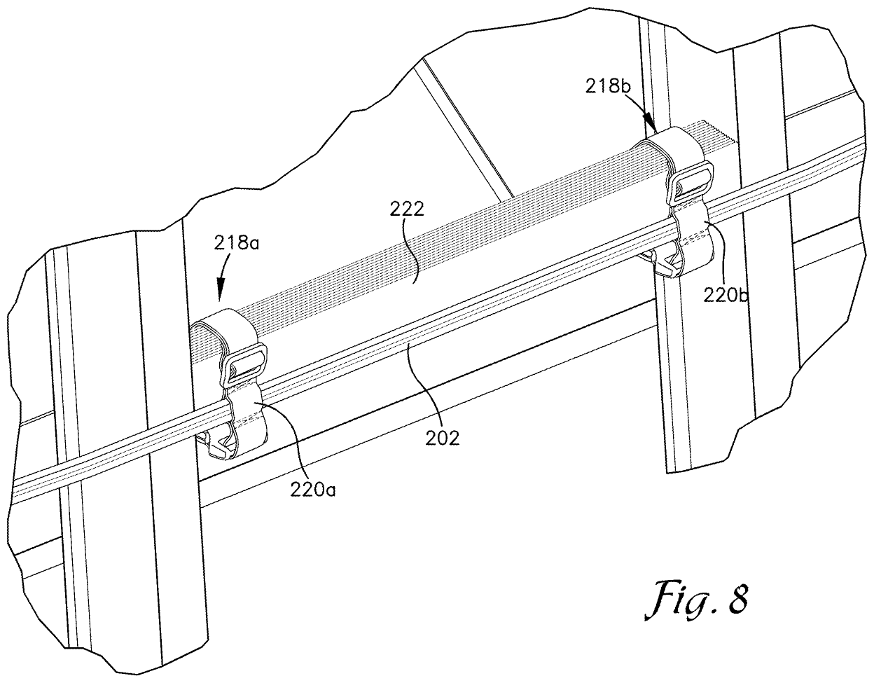

Thus, as seen in FIG. 8, the straps 218a, 218b can be tightened around a ladder rung 222 with the elastic cord 202 passing through the pockets 220a, 220b to secure the device 200 to the ladder.

As used herein, identification of an element with an indefinite article “a” or “an” or the phrase “at least one” is intended to cover any device assembly including one or more of the elements at issue. Similarly, references to first and second elements is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to be inclusive of structures and arrangements or designs thereof that are within the scope of this disclosure and readily identifiable by one of skill in the art and that can perform the particular function in a similar way. Certain features and sub-combinations are of utility and may be employed without reference to other features and sub-combinations and are contemplated within the scope of the claims.

What is claimed is:

1. A ladder securement device for securing a ladder to a structure, comprising:
an elastic cord extending between first and second ends;
first and second attachment hooks attached to said first and second ends, respectively; and
a strap slidably attached to the elastic cord and configured to attach around a rail and/or a rung of a ladder.

2. The device of claim 1, wherein the strap comprises a connection socket and a connection tab configured to mate together to secure the device around the rail and/or rung of a ladder.

3. The device of claim 2, wherein the connection tab comprise a slot, and wherein a portion of the strap passes through the slot such that the strap may be tightened around the rail and/or rung of a ladder.

4. The device of claim 1, wherein the strap comprise a loop handle to allow tightening the strap around the rail and/or rung of a ladder.

5. The device of claim 1, wherein the first and second attachment hooks each comprise an eyelet formed therethrough.

6. The device of claim 1, wherein the strap comprises a pocket formed therethrough, the pocket configured to receive the elastic cord to allow the strap to be slidably moved along the elastic cord.

7. A ladder securement device for securing a ladder to a structure, comprising:
an elastic cord extending between first and second ends;
first and second attachment hooks slidably attached to the elastic cord; and
first and second straps slidably attached to the elastic cord, wherein each of said first and second straps is configured to attach around a rail and/or a rung of a ladder.

8. The device of claim 7, wherein each strap comprises a connection socket and a connection tab configured to mate together to secure the corresponding strap around the rail and/or rung of a ladder.

9. The device of claim 8, wherein the connection tab comprises a slot, and wherein a portion of the strap passes through the slot such that the strap may be tightened around the rail and/or rung of a ladder.

10. The device of claim 7, wherein each of said first and second straps comprises a loop handle to allow tightening the corresponding strap around the rail and/or rung of a ladder.

11. The device of claim 7, wherein the first and second attachment hooks each comprise an eyelet formed therethrough.

12. The device of claim 7, wherein the strap comprises a pocket formed therethrough, the pocket configured to receive the elastic cord to allow the strap to be slidably moved along the elastic cord.

13. The device of claim 7, wherein each of said first and second attachment hooks comprises a hollow cylindrical main body portion configure to accept the elastic cord and allow the attachment hooks to slidably move along the cord.

14. The device of claim 7, further comprising first and second caps attached to the first and second ends, respectively, to contain the first and second attachment hooks and the first and second straps on the elastic cord.
